(19) United States
(12) Patent Application Publication
(10) Pub. No.: US 2026/0256162 A1
(43) Pub. Date: Sep. 3, 2026

(54) IMPROVED CHEESE RIPENING

(71) Applicant: FrieslandCampina Nederland B.V., Amersfoort (NL)

(72) Inventors: Rosan Wilhelmina Maria Van Uden, Nijmegen (NL); Herman Frank Burghout, 's-Hertogenbosch (NL)

(21) Appl. No.: 18/875,101

(22) PCT Filed: Jun. 14, 2023
(86) PCT No.: PCT/EP2023/065919

§ 371 Date: Dec. 13, 2024

(30) Foreign Application Priority Data
Jun. 15, 2022 (EP) 22179137.9

(51) Int. Cl. A23C 19/16; A01J 27/02; A23C 19/068

(52) U.S. Cl. CPC A23C 19/163; A01J 27/02; A23C 19/0688

(57) ABSTRACT

The invention relates to a method for providing a naturally ripened, block-shaped cheese of the hard or semi-hard type, comprising the steps of: (i) forming a block-shaped cheese from a curd by conventional means; (ii) applying a protective water-permeable coating layer onto the entire surface of the cheese, thereby obtaining a coated cheese; (iii) partially covering the coated cheese with a layer of a water-impermeable material thereby obtaining a partially covered coated cheese; and (iv) allowing the partially covered coated cheese to further ripen, wherein the block-shaped cheese comprises a top face, a bottom face and four faces that form the circumference of the block-shaped cheese, and wherein in step (iii) each of the four faces that form the circumference of the block-shaped cheese are at least partly covered with the layer of the water-impermeable material while leaving the top face and bottom face completely uncovered.

### FIELD OF THE INVENTION

The invention relates to the field of cheesemaking. In particular, it relates to methods for providing a naturally ripened hard or semi-hard cheese.

### BACKGROUND TO THE INVENTION

In general, most cheesemaking operations include the steps of providing a cheesemaking media, inoculating the media with an acid-producing microorganism, and forming a coagulum. The coagulum is cut to provide curd and whey, whereupon the curd is separated from the whey and subsequently, the whey is drained from the curd. The curd is pressed and then packed into a suitable form to provide a cohesive mass which, upon some ripening, becomes a cheese. Variations in one or more of the above steps for producing cheese result in production of the many varieties of cheese which are known. For example, in the case of a semi-hard or hard type cheese like Gouda cheese, the curd is pressed in a cheese mould and then transferred to the brine. The cheeses are left to soak in the brine for a time interval in the order of days and are then transferred to the warehouse for further ripening. During the ripening of the cheese the organoleptic quality of the cheese is developed.

In a conventional ripening method of a semi-hard or hard cheese, after brining, the young cheese is ripened at about 13 to 18° C. at a relative humidity of 70 to 80%, typically to an age of minimally four weeks for a young cheese and a year or more for an old cheese. During this ripening, also referred to in the art as “standard ripening” or “natural ripening”, the outside of the young cheese is provided with a conventional cheese covering means to protect the rind. Such cheese covering means typically is a coating of polyvinylacetate or some other water-permeable polymeric material, such as polysaccharides or polyethylene acetate. During the ripening process, the cheese loses moisture by water evaporation.

During natural ripening, the traditionally wheel- or cylindrically-shaped cheese is stored on (wooden) shelves. In the temperature and humidity controlled rooms where cheeses are aged, air naturally dries out the outside of cheese. Over time, this forms a crust on the outside of the cheese which becomes its rind. Cheesemakers monitor this process. The cheese is regularly turned, so that the upper and bottom sides are exposed to the air with intervals, while the “band” or circumference representing about 40% of the total surface area of the cheese, has no contact with the cheese shelves. This band area is continuously exposed to the air. As a consequence, the band area loses more water with the result that a dry and dark colored zone up to 7-8 mm or more e.g. 15-20 mm for an old cheese, and having an unattractive, chewy structure is formed.

EP-A-2 186 417 discloses a method for applying a semi-permeable coating to a cheese with variable coating layer thicknesses. Those surfaces of the cheese that show a higher moisture loss during ripening are provided with a thicker coating layer than the surfaces of the cheese having a lower moisture loss. The effect is a more uniform drying-in.

Alternatively, the young cheese is packaged in foil and is then ripened at a temperature of 4 to 7° C. to produce a rindless cheese of the semi-hard or hard type. This process is referred to as foil-ripening. A practical advantage is that a foil-ripened cheese, which often is block-shaped, gives no or hardly any cutting losses when cut to slices or bars. By comparison, the cutting loss with standard ripened cheese, also indicated with the term “naturally ripened cheese”, can run up to as much as 15%. Additionally, cheese ripened in this manner loses no moisture during ripening which is, in particular, of economic advantage.

However, a disadvantage of foil-ripening is that, due to the different ripening conditions, the cheese also undergoes a different type of ripening process. With this different type of ripening, the development of flavor lags. Merely increasing the ripening temperature to 12-14° C. as used in standard, natural ripening is no option, since in that case a bitter flavor develops. Additionally, ripening a cheese in foil at those temperatures produces a product having an undesired consistency. Typically, the structure or texture of such cheese is experienced as being either too sandy or too soft. Thus, foil ripening is unsuitable for traditionally ripening of hard or semi-hard cheeses.

Given the consumer's ever increasing preference for the taste and structure of naturally ripened cheeses, whilst at the same time minimizing cutting losses, the present inventors sought to improve the natural ripening process whilst using a cheese shape that minimizes cutting losses. More in particular, they aimed at developing a block-shaped natural semi-hard or hard cheese which can essentially be cut and sliced as easily as a foil-ripened cheese while not sacrificing the desired organoleptic properties of the cheese.

When ripening block-shaped cheese in a natural way, i.e. turning the cheese block, a dried, dark zone will develop (“dry-in”) particularly at the four faces which form the circumference of the block and which are continuously exposed to air during ripening. Top and bottom face are alternately protected from exposure to air, as they are in direct contact with the storage shelf on which the cheese block is put to ripen, and hence are less prone to the effects of dry-in.

WO 2021/005079 A1 discloses a method for providing a naturally ripened, block-shaped cheese comprising a top face, a bottom face and four faces that form the circumference of the block-shaped cheese. The method involves first applying a conventional water-permeable coating onto the entire surface of the cheese and subsequently partly covering the resulting coated cheese with a layer of water-impermeable material. This latter layer is applied onto at least all vertices and the four edges that connect the top face and bottom face of the block-shaped cheese, and preferably onto all four faces that form the circumference of the block-shaped cheese, thereby keeping top face and bottom face largely uncovered. The layer of water-impermeable material does, however, cover the outer edge of the top and bottom face. It was found that such outer edges of top and bottom face that are covered with water-impermeable material may cause the cheese to stick to the storage shelf, when the cheese is left to ripen, and hence may tear the outer layer, and sometimes even tear the underlying coating and even the cheese itself, when turning the cheese in the ripening process. This will lead to cheeses with a damaged coating, thus making the cheese more vulnerable to funghi and molds, or even to damaged cheeses. The consequence would be that the cheese product can no longer be sold thus causing a loss of valuable cheese products.

The present invention aims to overcome this problem whilst at the same time aiming to keep the aforesaid advantages, in particular minimal dry-in, good organoleptic properties, minimal cutting losses and easily cuttable and sliceable. Furthermore, the method should be easy to use and suitable for large scale industrial application.

### SUMMARY OF THE INVENTION

It was found that the aforesaid goals could be achieved by selectively covering certain parts of the block-shaped cheese which are most prone to drying in with a water-impermeable material, but at the same time ensuring that those parts of the cheese that are in direct contact with the storage shelf during ripening, i.e. the flat top and bottom face of the block-shaped cheese that are alternately in contact with the storage shelf during ripening, are completely free of such water-impermeable material. The water-impermeable material ensures that, during ripening, water evaporation from the cheese at those areas is minimized. By ensuring top and bottom face are completely free of such material the block-shaped cheese can be turned without tearing the water-impermeable layer at the circumferential faces of the block-shaped cheese and without tearing the normal coating or cheese itself.

### DETAILED DESCRIPTION

Accordingly, the invention relates to a method for providing a naturally ripened, block-shaped cheese of the hard or semi-hard type, comprising the steps of:
(i) forming a block-shaped cheese from a curd by conventional means;
(ii) applying a protective water-permeable coating layer onto the entire surface of the cheese, thereby obtaining a coated cheese;
(iii) partially covering the coated cheese with a layer of a water-impermeable material thereby obtaining a partially covered coated cheese; and
(iv) allowing the partially covered coated cheese to further ripen, wherein the block-shaped cheese comprises a top face, a bottom face and four faces that form the circumference of the block-shaped cheese, and
wherein in step (iii) each of the four faces that form the circumference of the block-shaped cheese are at least partly covered with the layer of the water-impermeable material while leaving the top face and bottom face completely uncovered.

The expression “block” or “block-shaped” as used herein refers to any cuboid shape i.e. any hexahedron having six faces, eight vertices and twelve edges, in particular a rectangular cuboid, i.e. a polyhedron in which all angles are right angles, all oppositely positioned faces are equal and all faces are rectangles. Preferred rectangular cuboids are those having six rectangular (non-square) faces, those having four rectangular (non-square)-shaped faces and two square faces and those having six square faces (i.e. cubes). FIG. 1 illustrates a typical cuboid shape that would qualify as “block-shaped” in the context of the present application. Such block has eight vertices (1), twelve edges (2) and six faces (3). In FIG. 1 the circumferential faces (3a), (3b), (3c) and (3d) together form the total circumferential surface of the block.

The block-shaped cheese of the present invention comprises a top face and a bottom face and, consequently, four side faces that together form the circumferential surface of the block. The top and bottom face are those faces that are (alternately) in direct contact with the storage shelf during ripening and will typically be those faces having the largest surface of all six faces of the block. Exact dimensions can be selected as desired, influenced by factors such as e.g. end use of the cheese (for retail or businesses) and available equipment for turning the cheese during ripening and for providing the cheese with the water-impermeable layer. For example, suitable dimensions include blocks having dimensions (length×breadth×height) in the range of 30-60 cm×20-40 cm×5-20 cm, more suitably 40-55 cm×25-35 cm×8-15 cm. A particularly suitable dimension is approximately 50 cm×30 cm×10 cm. The top and bottom face would then be the largest faces, i.e. those having a surface of 50 cm×30 cm=1500 cm².

Step (i) comprises the formation of a block-shaped cheese from a curd by conventional means, typically involving providing a conventional curd by inoculating a cheese making media with an acid-producing microorganism to form a coagulum, cutting the coagulum to provide curd and whey, and separating the curd from the whey; pressing and packing the curd into the desired block shape followed by transfer to a brine.

After the cheese is formed, i.e. immediately following brining, a conventional water-permeable (plastic) coating layer is applied in step (ii) onto the entire surface of the cheese to offer surface protection against yeasts, fungi and molds during subsequent cheese ripening. For example, a liquid coating comprising polyvinyl acetate (PVA) is applied directly to the surface of the whole cheese at the start of ripening (sometimes also referred to as aging or maturation). Such conventional PVA coatings are typically applied by applying PVA-based aqueous dispersions onto the cheese surface. The cheese subsequently passes through a coating machine with rotating flaps, which spread the dispersion evenly upon all faces of the block shaped-cheese. Upon drying, a coherent plastic film is formed that offers a protective coating against mechanical damage and reduces moisture evaporation to some extent. Once at least one layer of water-permeable coating material has been applied onto the entire surface of the cheese and has dried, the cheese is put on a hard surface (typically a shelf) to start the ripening process. It is important that the cheese can lose moisture during the natural ripening and some moisture, therefore, should be able to evaporate from the cheese through the coating. After a few days of ripening a second uniform water-permeable coating may be applied on those faces of the block-shaped cheese not facing the shelf on which it lies for ripening, typically by painting PVA or some other suitable water permeable coating material onto the exposed cheese surfaces. Once the coating material has dried, the cheese is turned and the now upwardly facing side of the cheese and typically also the circumferential faces are provided with a further water permeable protective coating layer which is allowed to dry before the cheese is turned again. This process may be repeated several times during ripening, before step (iii) but also after step (iii) of the present process. The protective coating may contain color and/or antifungal agent, such as natamycin. Suitable conventional coating materials are also disclosed in EP-A-2 186 417.

In step (iii) of the method of the invention the coated cheese obtained in step (ii) is partially covered with a layer (or further coating) of a water-impermeable material such that each of the four faces that form the circumference of the block-shaped cheese is at least partly covered with the layer of the water-impermeable material while leaving the top face and bottom face completely uncovered. Suitably at least 80%, preferably at least 90%, more preferably at least 99% and most preferably 100% of the surface of each of the four faces (i.e. each of (3a), (3b), (3c) and (3d) in FIG. 1) that form the circumference of the block-shaped cheese is covered with the layer of the water-impermeable material. This is illustrated by FIG. 2: all four circumferential faces (two of which are shown) of the block-shaped cheese are completely covered with a wax layer (4) whilst top face (5) and bottom face (not shown) are completely uncovered. The reference to “completely” in this context means at least 99% of the surface of the relevant face. See FIG. 2.

The resulting partially covered coated cheese is subsequently allowed to further ripen in step (iv) by exposure to air. Due to the further layer of water-impermeable material applied, any moisture evaporating from the ripening cheese can now only leave the cheese through that part of the cheese surface which is not covered by this further layer of water-impermeable material and which is not in contact with the shelf on which the cheese is stored during ripening. As a result, less moisture will leave the cheese and the thickness of the dried, dark zone of the cheese which is typically observed at the outer circumference (i.e. the circumferential faces) of conventionally ripened natural cheeses is reduced significantly, thereby facilitating cutting and slicing of the cheese and minimizing cutting losses.

Depending on the desired effect, the layer of water-impermeable material can be applied directly after applying a first layer of water-permeable coating brining or at any other time point during the ripening process. For a young cheese, it was found the layer of water-impermeable material is suitably applied between 2 days and 4 weeks, preferably between 1 week and 3 weeks and more preferably between 10 and 16 days, after completion of step (ii). For a more mature cheese, the further coating can be applied later e.g. after 4, 8, 12 or 24 weeks after step (ii), preferably after 4, 6 or 8 weeks after completion of step (ii) by which time sufficient crust has formed. The time period during which the cheese is partially covered by the layer of water-impermeable material can vary according to specific circumstances, like the type of cheese, the ripening conditions and/or the desired degree of maturation. Suitably the layer of water-impermeable material is present during at least 4 weeks of ripening. It can remain present as long as desired, conveniently during the full ripening period of the cheese.

The materials used for the further layer should be water-impermeable, thereby preventing moisture to leave the cheese where such further coating is applied. In one embodiment the water-impermeable material applied is wax. In principle any wax that is impermeable and can be applied onto cheese can be used. Such waxes are known in the art and include paraffin wax and cheese wax. Suitable materials are also disclosed in EP-A-0 2186 417 and include mono- and diglycerides having a melting temperature above 30° C., acetylated mono- and/or diglycerides and mixtures of one or more of these. An example of a suitable cheese wax are Paradip™ waxes, such as Paradip™ NW yellow 5990, Paradip Nowax™ and Paradip™ KS1/KS2.

The wax layer can be applied in step (iii) by any suitable method. For example, step (iii) may comprise smearing wax onto the four faces that form the circumferential surface of the cheese block by means of a brush or other instrument suitable for smearing. The wax may also be applied using a roller similar to a paint roller. For example, placing a roller in a liquid wax bath such that the roller is in continuous contact with the wax while passing the circumferential faces of the cheese block successively over such roller could be a suitable way to apply the wax. Of course “painting” the circumferential faces of a cheese block with a roller that is saturated with wax is also a possibility. As a further alternative all circumferential faces of the block may be successively dipped in a bath of liquid wax by allowing each circumferential face to only touch the surface of the liquid wax in order to avoid any wax to cover top and bottom face, and allowing the wax to dry. Dipping time per face may vary, inter alia depending on the amount of wax and hence thickness of the wax layer to be applied. Typical dipping time per face may range from 5 seconds to 1 minute, suitably from 10 seconds to 30 seconds. Each face may be dipped more than once, for example 2 or 3 times. In case of multiple dips per face, some time is allowed between two successive dips to allow the wax to dry. Depending on the type of wax used this may typically take between 10 seconds and 2 minutes. In a further embodiment the four circumferential faces may be successively dipped once first, after which at least one further round of successive dipping is performed. The dipping is suitably performed by a robotic arm programmed for such dipping action. The liquid wax can subsequently be allowed to dry, either by enforced cooling or by unenforced cooling.

The amount of wax to be applied as the wax layer may vary within wide limits. However, it was found that good results are obtained when using an amount of wax on each circumferential face of the cheese block in the range of at least 5 milligrams of wax per square centimeter of cheese (mg/cm²), suitably at least 10 to 90 mg/cm² and more suitably at least 15 mg/cm². The upper limit is mostly determined by practical considerations, as a very thick wax layer would make handling of the cheese block more cumbersome whilst at the same time not resulting in less moisture loss than when applying a thinner wax layer. Accordingly, the amount of wax applied onto the circumferential faces of a cheese block will typically not exceed 100 mg/cm², more suitably 80 mg/cm², and most suitably will not be higher than 60 mg/cm².

Step (iv) of a method provided herein comprises allowing the partially enclosed cheese to further ripen in the conventional way, typically by regularly turning the cheese block that is placed on a hard surface (shelf, draining mat, board or the like) to age and ripen, so that top and bottom face are alternately exposed to air whilst the circumferential faces are continuously exposed to air. During such conventional ripening the parts of the cheese block not covered by the water-impermeable layer and exposed to air are suitably provided with at least one further thin layer of water-permeable coating. Such further thin layer of water-permeable coating may also be applied onto the layer of water-impermeable material applied onto the circumferential faces each time the cheese block is turned. More suitably, each time the cheese block is turned, all faces of the cheese block exposed to air are provided with a further thin layer of water-permeable coating, including the circumferential faces. Such procedure is well known in the art.

Ripening conditions are well known. Typically the temperature during ripening is between 1° and 20° C., optimum ripening temperatures are in the range of 12 to 15° C. Relative air humidity during ripening is typically in the range of 75 to 90% at the ripening temperature. Ripening typically takes place in conditioned spaces such as a cheese cave or ripening cell. Ripening time for hard and semi-hard cheeses may vary within broad limits and depends on the type of cheese and age desired. For example, a semi-hard cheese such as a Gouda-type cheese will usually be allowed to ripen for at least 4 weeks (young matured cheese) whilst old or fully matured cheese may ripen for 10 to 12 months or even longer.

The partial covering of the block-shaped coated cheese with a further water-impermeable layer can significantly prevent the weight loss during cheese ripening. For example, it can result in a weight loss of less than 4%, preferably less than 3%, during a ripening period of about 6 weeks, or less than 5%, preferably less than 4%, during a ripening period of about 8 weeks. Compared to the weight loss of conventional prepared block-shaped cheeses, i.e. block-shaped cheeses without the water-impermeable layer on the circumferential faces, the weight loss during the entire ripening stage could be reduced by as much as 30 to 35%.

The concept of the present invention is applicable to any type of block-shaped cheese. Accordingly, the present invention is suitably applied for full fat cheeses, notably 48+-cheese, such as Gouda cheese, as well as for low fat cheeses, such as a 30+-cheese made from skimmed or semi-skimmed milk (the 48+ cheese and 30+ cheese having fat contents of approximately 48% by weight and approximately 30% by weight based on dry matter, respectively).

The invention is further illustrated by the following examples without limiting the invention to these specific embodiments.

### LEGEND TO THE FIGURES

FIG. 1: Schematic representation of a block-shaped cheese indicating all vertices, edges and faces.

FIG. 2: Schematic representation of a block-shaped cheese with a layer of water-impermeable material at the faces that form the circumferential surface of the block-shaped cheese while leaving top and bottom face completely uncovered.

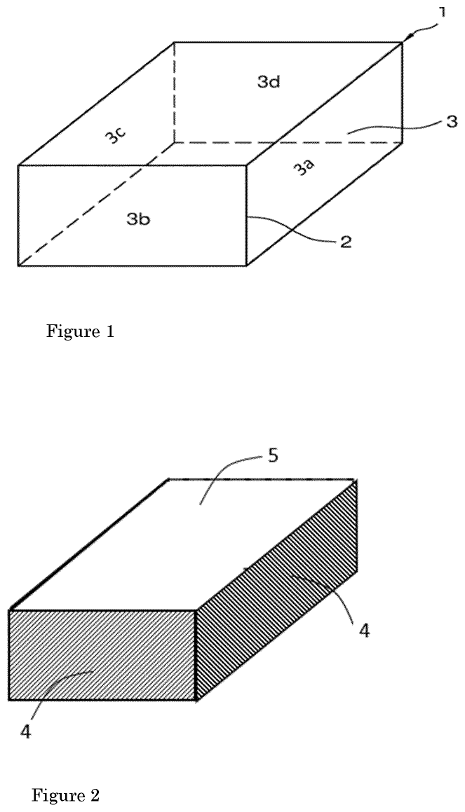

### EXAMPLES

### Example

Following brining 30 block-shaped cheeses of the Gouda 48+ type (dimensions: 50 cm×30 cm×10 cm) from the same production run were placed on a storage shelf in a ripening cell that was kept at about 13° C. (relative humidity approximately 80%). The uncovered faces of all blocks were provided with a conventional thin layer of water-permeable polyvinyl-acetate (PVA) cheese coating. Every 3 to 4 days all cheese blocks were turned and following such turning all faces exposed to air were covered with a further thin layer of PVA coating.

After 14 days of ripening 15 out of the 30 cheese blocks were provided with a layer of a water impermeable formulated cheese wax based on acetoglycerides (Paradip Nowax®) on all their circumferential faces (i.e. the faces of 10 cm×30 cm and of 10 cm×50 cm) while leaving top and bottom face (i.e. the faces of 30 cm×50 cm) of each block completely uncovered. The wax was applied with a paint roller in two layers, thereby completely covering each circumferential face of the five blocks. Per block a total of 26 grams of wax was applied onto the circumferential faces, corresponding to an amount of approximately 16.3 mg/cm². These blocks are referred to as the “wax-coated cheeses”.

After the wax layer had dried the wax-coated cheeses were turned and a new PVA layer was applied onto the faces of the cheeses that were exposed to air, including the circumferential faces covered with the wax layer. In general, the following coating regime was subsequently applied: during the first 4 weeks after applying the wax layer the cheese blocks were turned twice a week (i.e. every 3-4 days) and immediately following such turning a PVA layer was applied onto the faces of the cheeses that were exposed to air (including the circumferential faces covered with the wax layer). From week 5 until 9 the cheese was subsequently turned once a week and a PVA layer was applied onto all faces exposed to air immediately after such turning, from week 10 until 24 the cheese block was turned once every 2 weeks and a PVA layer was applied onto all faces exposed to air immediately after such turning and from week 25 onwards the cheese block was turned once every 3 weeks and a PVA layer was applied onto all faces exposed to air immediately after such turning. During the ripening process the wax coated cheeses did not stick to the shelf upon turning and hence could be turned without rupturing or otherwise damaging the wax layer, PVA coating or cheese.

The remaining 15 cheese blocks which were not provided with a wax layer were turned and provided with further PVA coating according to the same regime as the wax-coated cheeses (the “reference cheeses”).

Moisture loss of the cheeses was determined as follows. Each cheese block was weighed after 14 days of ripening; in case of the wax-coated cheese such weighing took place just after the complete wax layer had been applied and had dried before turning (“starting weight”). Each cheese block was subsequently also weighed at the age indicated in the table and the weight loss was calculated as the difference in weight between starting weight and weight at the different ages relative to the starting weight. This weight loss is, accordingly, expressed as percent by weight based on the starting weight of the cheese block (wt %) and is in fact the moisture loss. The average moisture loss (AML) of 10 reference cheeses and the AML of 10 wax-coated cheeses at different ages was calculated. The AVLs thus found are indicated in Table 1.

The moisture loss reduction (MLR) of the wax-coated cheese and reference cheese can be calculated as:

$$MLR ( \% ) = 100 - \frac{AML wax coated cheese ( wt \% )}{AML reference cheese ( wt \% )} \times 100 \%$$

The MLR of the reference cheese and of the wax-coated cheese at the different ages was calculated. The MLRs thus found are indicated in Table 1.

As can be seen from Table 1 the MLR of the wax-coated cheese according to the invention was significantly less at the different ages than the MLR of the reference cheese under otherwise identical conditions. Hence, drying in of the cheese is significantly reduced by applying the wax layer at the circumferential faces of the cheese block, whilst enabling turning of the wax coated cheese block during ripening without any damage to the wax layer, PVA coating or cheese.

TABLE 1
Moisture loss reduction

| Age (weeks) | 4 | 9 | 16 | 26 |
|---|---|---|---|---|
| AML reference cheese (wt %) | 2.9 | 6.3 | 8.9 | 11.9 |
| AML wax coated cheese (wt %) | 1.9 | 4.3 | 6.2 | 8.6 |
| MLR (%) | 34.5 | 31.7 | 30.3 | 27.7 |

Furthermore, four wax coated cheeses of the same batch of respectively 4, 9, 17 and 30 weeks of age were processed into slices. The same procedure was carried out with four reference cheeses of the same batch of 4, 9, 17 and 30 weeks of age.

When compared with reference cheeses of the same age, the wax-coated cheeses exhibited a significantly thinner dry and dark colored zone at the circumferential faces of the slices, thus also supporting the conclusion from Table 1 that during ripening less evaporation of water occurs from a wax-coated cheese than from a reference cheese.

1. A method for providing a naturally ripened, block-shaped cheese of the hard or semi-hard type, comprising the steps of:
(i) forming a block-shaped cheese from a curd by conventional means;
(ii) applying a protective water-permeable coating layer onto the entire surface of the cheese, thereby obtaining a coated cheese;
(iii) partially covering the coated cheese with a layer of a water-impermeable material thereby obtaining a partially covered coated cheese; and
(iv) allowing the partially covered coated cheese to further ripen,
wherein the block-shaped cheese comprises a top face, a bottom face and four faces that form the circumference of the block-shaped cheese, and
wherein in step (iii) each of the four faces that form the circumference of the block-shaped cheese are at least partly covered with the layer of the water-impermeable material while leaving the top face and bottom face completely uncovered.

2. Method according to claim 1, wherein in step (iii) at least at least 90% and preferably at least 99%, of the surface of each of the four faces that form the circumference of the block-shaped cheese is covered with the layer of the water-impermeable material.

3. Method according to claim 1, wherein step (iii) is carried out between 2 days and 4 weeks, preferably between 1 week and 3 weeks and more preferably between 10 and 16 days, after completion of step (ii).

4. Method according to claim 1, wherein the water-impermeable material is wax.

5. Method according to claim 1, wherein the cheese is a low fat cheese, preferably a 30+-cheese made from skimmed or semi-skimmed milk.

6. Method according to claim 1, wherein the cheese is a full fat cheese, preferably a 48+-cheese.
